(19) United States
(12) Patent Application Publication
(10) Pub. No.: US 2005/0144575 A1
(43) Pub. Date: Jun. 30, 2005

(54) Circuit arrangement design method and circuit arrangement design program

(75) Inventors: Katsushi Aoki, Kawasaki (JP); Yasushi Itoh, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/064,862

(22) Filed: Feb. 25, 2005

Related U.S. Application Data
(63) Continuation of application No. PCT/JP03/02515, filed on Mar. 4, 2003.

(51) Int. Cl. G06F 17/50

(52) U.S. Cl. 716/3; 716/18

(57) ABSTRACT

A circuit arrangement design method includes a step of performing a logic conversion of logic, the logic forming a circuit arrangement where a cell arrangement and a connection arrangement between cells are provisionally arranged prior to a detailed mounting design, and thereby wiring efficiency is improved.

### CROSS-REFERENCE TO RELATED APPLICATION

This application is a U.S. continuation application filed under 35 USC 111(a) and claiming benefit under 35 USC 120 and 365(c) of PCT application No. JP2003/002515 filed on Mar. 4, 2003. The foregoing application is hereby incorporated by reference.

### BACKGROUND OF THE INVENTION

1. Field of the Invention

The present invention generally relates to circuit arrangement design methods and circuit arrangement design programs, and more particularly, to a circuit arrangement design method and circuit arrangement design program, whereby the number of design steps can be effectively decreased in mounting design of a large-scale integrated (LSI) circuit or the like.

2. Description of the Related Art

There is a tendency that the influence on whole circuit layout by wiring arrangement design regarding connections between circuit cells cannot be ignored due to recent high integration of circuits. Because of this, it becomes important to improve the efficiency of the wiring by removing inefficient wiring as much as possible. In addition, there is another problem, namely signal transmission delay due to the connections between the cells accompanying technology by which the circuit is made minute. In this state, it becomes important from the perspective of improvement of the performance of the LSI circuit (improvement of an operating frequency) to improve the wiring efficiency (removal of a wiring detour, easing of local wiring concentrations, or the like).

For the purpose of solving the above-mentioned problems, for example, Japanese Patent Application Publication No. 5-61939 discloses a method whereby delay time is calculated based on the result of the wiring design so that a buffer is inserted and logic is changed to reduce the delay time. Furthermore, Japanese Patent Application Publications No. 2000-357740 and No. 7-14927 disclose a method whereby the signal delay time is shortened and a signal waveform is improved by increasing the driving ability of a cell, inserting a repeater cell, or the like. Japanese Patent Application Publication No. 8-6972 discloses a method whereby assignment of a pin is changed to remove wiring crossings for the purpose of shortening the connection path between paths of a multilayer substrate.

However, according to the above-mentioned related art, after a final mounting design is performed, design change for further improvement of the wiring efficiency is performed. Hence, there is a problem of extreme increase of the number of design processes due to a return by manual methods (manual return).

### SUMMARY OF THE INVENTION

Accordingly, it is a general object of the present invention to provide a novel and useful circuit arrangement design method and circuit arrangement design program, in which one or more of the problems described above are eliminated.

Another and more specific object of the present invention is to provide a circuit arrangement design method and circuit arrangement design program implemented by a computer, whereby wiring efficiency can be effectively improved without drastic increase of the number of design processes.

The above object of the present invention is achieved by a circuit arrangement design method, including:
a step of performing a logic conversion of logic, the logic forming a circuit arrangement where a cell arrangement and a connection arrangement between cells are provisionally arranged prior to a detailed mounting design, and thereby wiring efficiency is improved.

The above object of the present invention is also achieved by a circuit arrangement design program implemented by a computer, comprising an instruction for implementing a step of:
performing a logic conversion of logic, the logic forming a circuit arrangement where a cell arrangement and a connection arrangement between cells are provisionally arranged prior to a detailed mounting design, and thereby wiring efficiency is improved.

According to the present invention, in a LSI circuit design, for example, logic and mounting information is read in, virtual wiring is performed according to the information, a wiring efficiency improvable part is extracted from the result, virtual wiring correction is performed by performing wiring conversion and logic conversion, and conversion of the total wiring amount and the signal propagation delay amount accompanying the correction is simulated, so that a logic design and mounting design in which the wiring efficiency is improved can be obtained.

That is to say, according to the present invention, in the LSI circuit design, for example, prior to a detailed mounting design, arrangement of necessary cells and connection between the cells are provisionally performed in the design by using an automatic wiring design tool or the like. Considering the state of the wiring, the wiring efficiency improvable part is searched for. If necessary, wiring change including logic conversion is performed to the found wiring efficiency improvable part, so that the wiring efficiency improvement can be achieved. Detailed mounting design is performed based on the provisional design in a state where the wiring efficiency is improved by the above-mentioned process. As a result of this, even if a possibility of manual return exists due to generation of the necessity of a further wiring efficiency improvement, by using a circuit simulation after the detailed mounting design is performed, it is possible to effectively reduce the likelihood of the manual return. Thus, it is possible to effectively prevent the drastic increase of the number of design processes due to generation of the design change based on the manual return.

Other objects, features, and advantages of the present invention will become more apparent from the following detailed description when read in conjunction with the accompanying drawings.

### BRIEF DESCRIPTION OF THE DRAWINGS

FIG. 1 is a flowchart showing an example of LSI circuit design processes where a wiring efficiency improvement method of an embodiment of the present invention is applied;

FIG. 2 is a flowchart showing details of a step of mounting design shown in FIG. 1;

FIG. 3 is a block diagram showing a structure of wiring efficiency improvement application software of the embodiment of the present invention;

FIG. 4 is a flowchart showing processing of the wiring efficiency improvement application software of the embodiment of the present invention;

FIG. 5A and FIG. 5B are views for explanation of an example of wiring efficiency improvement processing by the wiring efficiency improvement method of the embodiment of the present invention, namely part 1 of a local wiring change;

FIG. 6A and FIG. 6B are views for explanation of another example of the wiring efficiency improvement processing by the wiring efficiency improvement method of the embodiment of the present invention, namely part 2 of the local wiring change;

FIG. 7A and FIG. 7B are views for explanation of another example of the wiring efficiency improvement processing by the wiring efficiency improvement method of the embodiment of the present invention, namely part 1 of a broad view wiring change;

FIG. 8A and FIG. 8B are views for explanation of another example of the wiring efficiency improvement processing by the wiring efficiency improvement method of the embodiment of the present invention, namely part 2 of a broad view wiring change;

FIG. 9A, FIG. 9B, and FIG. 9C are views for explanation of another example of the wiring efficiency improvement processing by the wiring efficiency improvement method of the embodiment of the present invention, namely part 3 of a broad view wiring change; and

FIG. 10A and FIG. 10B are views for explanation of another example of the wiring efficiency improvement processing by the wiring efficiency improvement method of the embodiment of the present invention, namely part 4 of a broad view wiring change.

### DETAILED DESCRIPTION OF THE PREFERED EMBODIMENTS

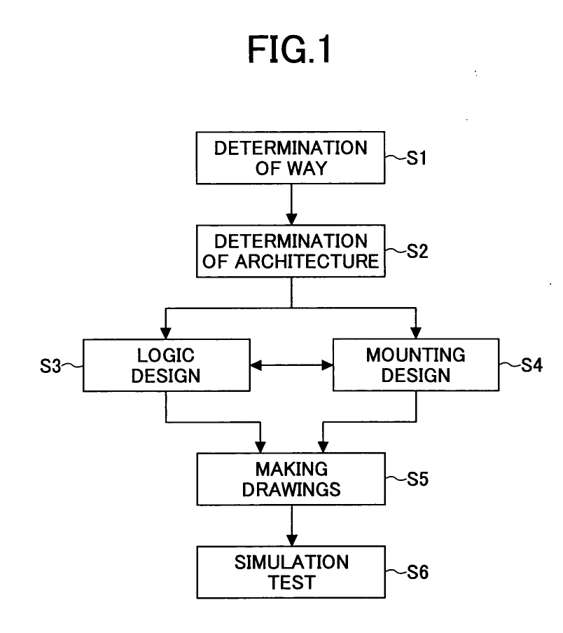

A description is next given, with reference to FIG. 1 through FIG. 10B, of embodiments of the present invention.

FIG. 1 is a flowchart showing an example of LSI circuit design processes where the present invention is applied. In step S1, a basic way of a LSI circuit is determined following a request from a user. In step S2, a proper architecture satisfying the way determined in step S1 is examined. In step S3, a logic design is implemented based on the architecture obtained in step S2. In step S4, a mounting design is implemented based on the logic. It is preferable that the logic design and mounting design be performed by closely relating them to each other and that design information be fed-back to each other so that a proper mounting design can be achieved. After the proper mounting design is obtained, design drawings of the design are made in step S5. Based on the design drawings, a detailed action simulation test is performed in step S6.

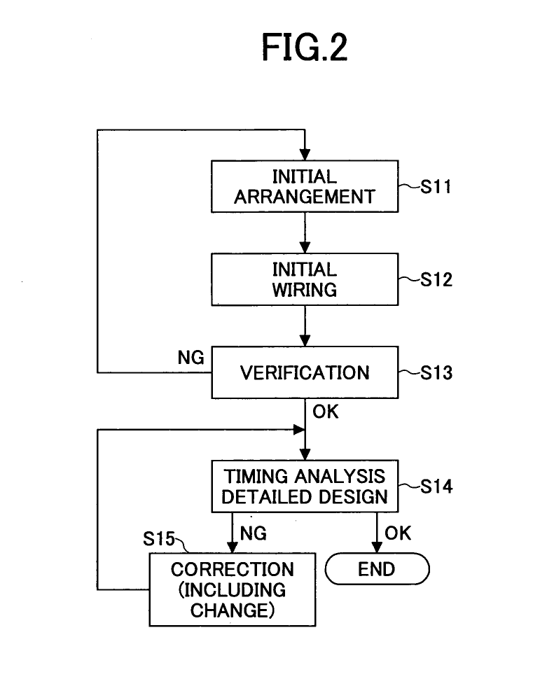

FIG. 2 is a flowchart showing details of a step of mounting design shown in FIG. 1. In step S11, initial arrangement design of cells forming a circuit is performed. In step S12, following the arrangement design of the cells, design for connecting between the cells based on the result of the logic design determined in step S3 is performed. In step S13, a logic simulation is performed following the circuit design made by the initial design and whether this design is consistent with the designated logic design is verified. As a result of this, if a problem is found, the process goes back to steps S11 and S12 so that the initial design is modified. Thus, in a case where a mounting design consistent with the designated logic design is finally obtained by repeating steps S11, S12 and S13, detailed mounting design including a timing analysis of the mounting design circuit is performed in step S14.

In the timing analysis and detailed design of step S14, a detailed mounting design necessary for actual LSI manufacturing is performed by adding detailed design data of a circuit element which can actually be applied as a circuit cell, manufacturing conditions of the circuit substrate, or the like based on the initial design data obtained by repeating steps S11, S12, and S13. During the detailed manufacturing design, an action is simulated by considering a physical property of an applied wiring material so that whether the design satisfies a basic way including a signal transmission delay condition determined by step S1 shown in FIG. 1 is verified. In a case where the way does not satisfy the basic way, that is, in a case where the signal transmission delay time obtained by the simulation is not within an allowable delay time, a small correction is added in step S15. More specifically, the signal transmission delay can be shortened by shortening a corresponding wiring length or increasing a driving force of the cell (inserting a repeater, increasing a gate size, or the like), for example. In step S14, a timing analysis is performed again to a result of such a correction. By repeating these steps S14 and S15, it is possible to finally obtain a mounting design satisfying the desirable way.

The initial arrangement in step S11 and the initial wiring in step S12, unlike the detailed design in step S14, are performed by modeling an application cell to in a simple model. Therefore, it is possible to implement them in a relatively short period of time by using a well-known automatic wiring arrangement tool such as application software or the like.

In the conventional art, a designer has to determine, in step S13, by his eyes, whether there is a problem in the initial design about the initial design data obtained by using such an automatic wiring arrangement tool. According to the conventional art, whenever there is the problem in the initial design about the initial design data, the designer has to correct the design manually and repeat performing the logic simulation against the result of the correction. After finally obtaining an initial design not having the problem, the designer performs a detailed mounting design accompanying the timing analysis simulation in step S14 on the result. In a case where there is the problem in the result, the designer has to perform the design correction in step S15.

However, in the above-mentioned conventional method, it can be expected that an error of the designer may happen in the case of such a visual operation of the designer on the initial design. As a result of this, it can be expected that a large number of manual returns may happen in the detailed design in step S14. In this case, it takes time to redesign and may take a lot of time to obtain a timing convergence, namely make the calculated signal transmission delay time be equal to or less than the desirable delay time. This causes increases of the number of design processes and costs. In addition, repeating the timing analysis simulation causes use of a computer for a long period of time and consumption of a large amount of power of a CPU of the computer. Furthermore, in the conventional art, since it is necessary to select a chip which can be applied to a case where a gate size is increased to increase the driving force of the cell for the purpose of the timing convergence, it is necessary to select a large chip in the initial step to avoid such a time-consuming job. This causes, as a result, an increase of product costs.

On the other hand, in the present invention, wiring efficiency improvement application software is installed in the automatic wiring arrangement tool applied to the initial arrangement in step S11 and the initial wiring in step S12. Hence, in these steps, it is possible to securely and automatically search the wiring efficiency improvable part in these steps. Whenever the wiring efficiency improvable part is found as a result of the search, design correction including the logic conversion is automatically performed. Because of this, it is possible to solve various problems such as detour wiring, increase of the amount of the wiring, necessity of the increase of the gate size, or the like, in the initial arrangement wiring step. As a result of this, it is possible to effectively reduce generating manual returns in the detailed mounting design in step S14.

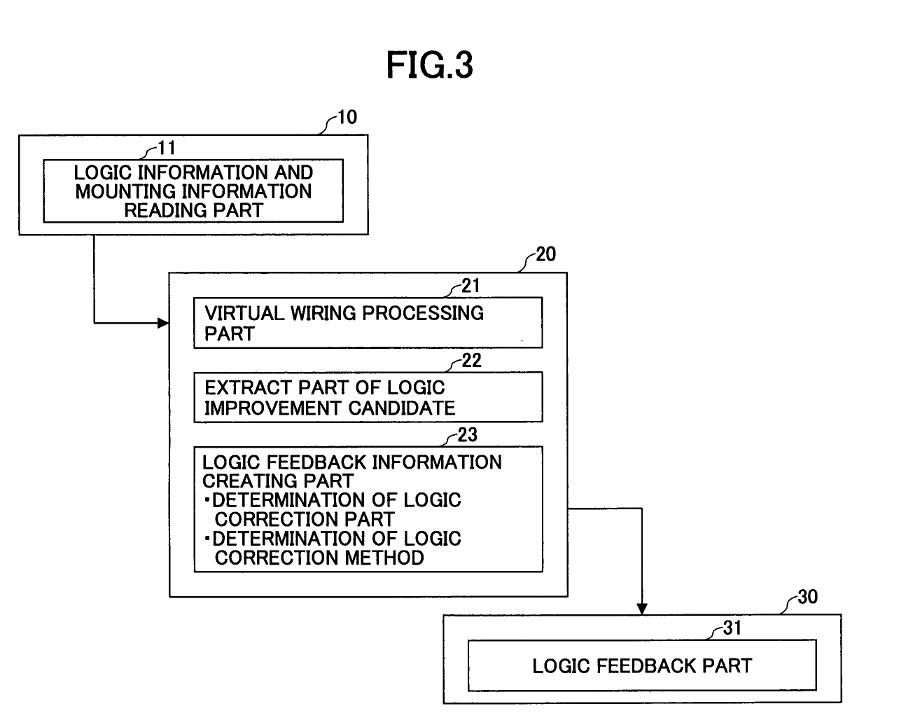

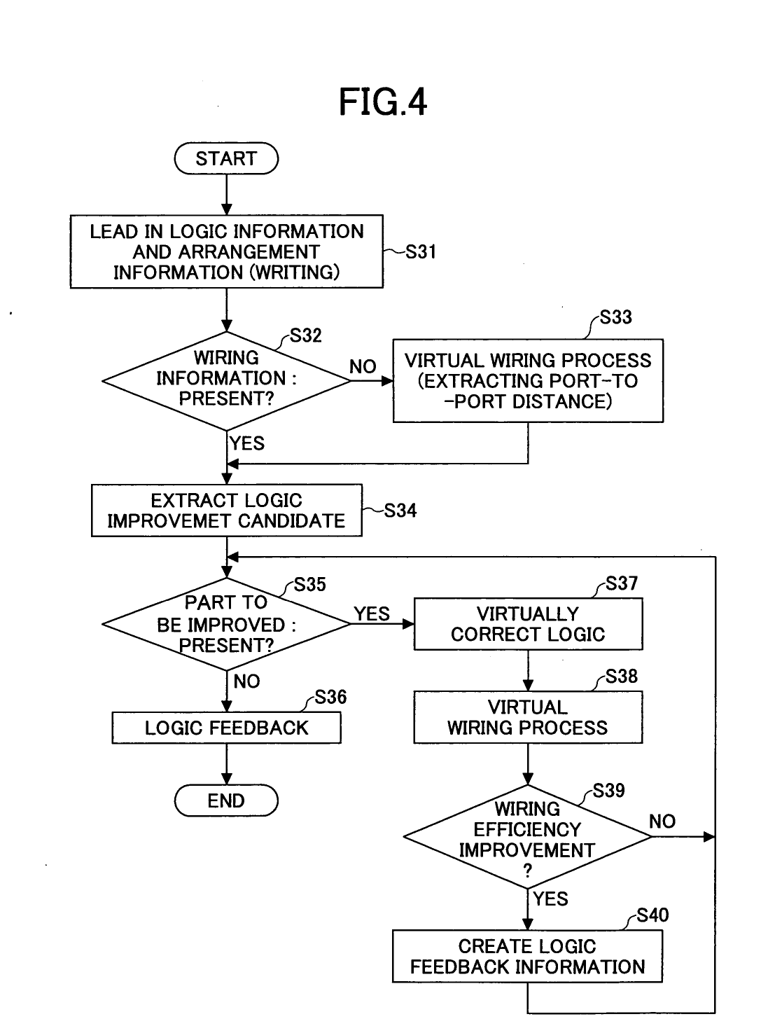

FIG. 3 is a block diagram showing a structure of the wiring efficiency improvement application software of the embodiment of the present invention. FIG. 4 is a flowchart showing processing of the wiring efficiency improvement application software of the embodiment of the present invention. As shown in FIG. 3, the software includes an input part 10, a data processing part 20, and an output part 30. The input part 10 includes a logic information and mounting information reading part 11 and reads the logic design information obtained in step S3 in FIG. 1 and the initial mounting design information obtain in steps S11 and S12 in FIG. 2 (step S31).

The data processing part 20 includes a virtual wiring processing part 21, an extract part 22 of a logic improvement candidate, and a logic feedback information creating part 23. In the virtual wiring processing part 21, in a case where the wiring information is not included in the logic information and mounting information read by the input part 10 (in a case of “NO” in step S32 in FIG. 4), wiring for connection between the cells is virtually performed (step S33). The wiring for connection between the cells forms a logic circuit shown by the information read in step S31. Next, in the extract part 22 of the logic improvement candidate, wiring contents of the connection between the cells read in step S31 or obtained by the virtual design in step S33 are examined. Whether there is a candidate for the wiring efficiency improvement in the contents is determined. If there is a candidate for the wiring efficiency improvement in the contents, corresponding parts can be extracted (step S34).

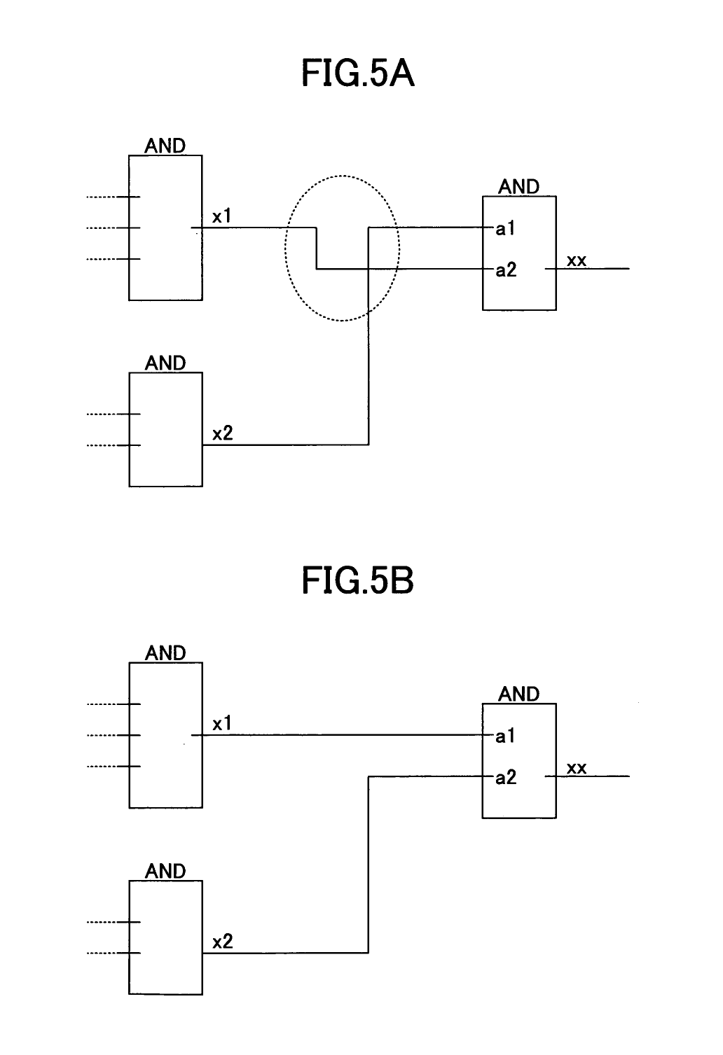

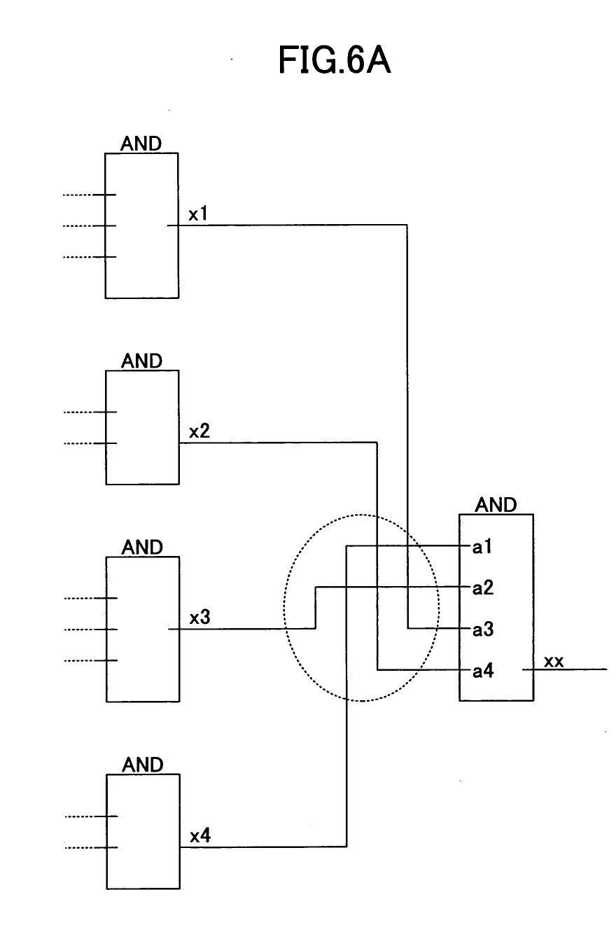

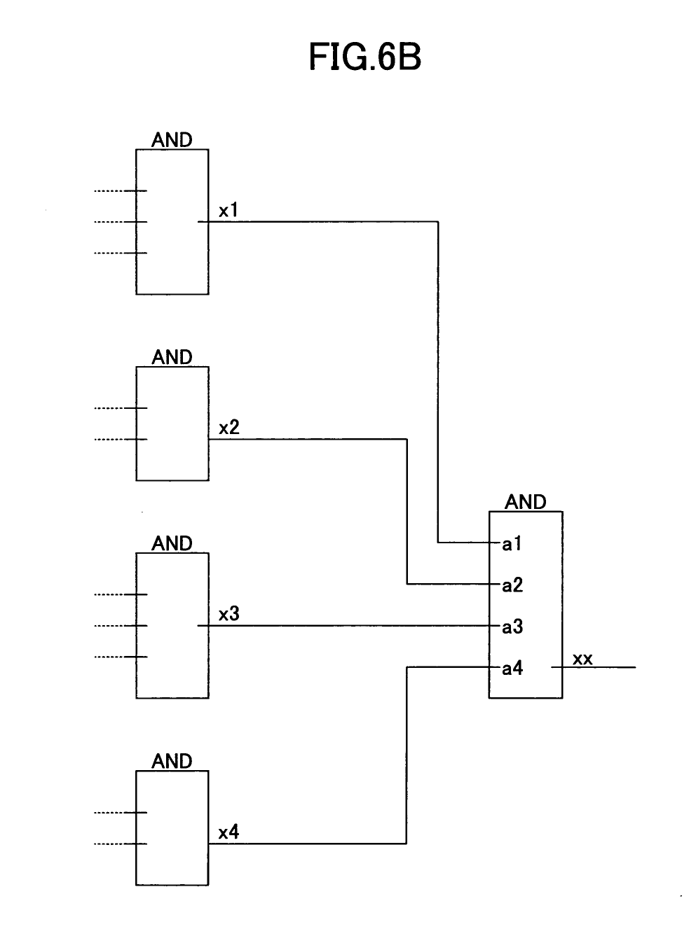

Next, in a case where there is an improvement part as a result of step S34 (in a case of “YES” in step S35), the logic feedback information creating part 23 corrects the logic of the circuit about the part in step S37 if necessary. The logic feedback information creating part 23 performs virtual wiring (wiring correction) processing as following the corrected contents (step S38) and determines whether the wiring efficiency improvement is achieved as a result (step S39). In a case where the result is “NO”, the process goes back to step S35 and the above-discussed processes (steps S35, S37, S38 and S39) are repeated until the wiring efficiency improvement is achieved as a result (namely unitil “YES” of step S39). If the result in step S39 is “YES”, ideas of the logic correction and virtual wiring in this case are applied and stored as formal logic design data. The “logic correction” in this case includes, for example, a change (local change) of the connection port of the cell as shown in FIG. 5A, FIG. 5B, FIG. 6A, FIG. 6B or the like, is included.

After the processes in steps S35, S37, S38, S39, and S40 are repeated so that all of the improvement candidate parts extracted in step S34 are processed, final logic design data are output in step S36 by the logic feedback part 31 of the output part 30. That is, the contents where correction is added in step S40 to the logic information and the arrangement design information read in step S31 are output as final logic information and arrangement design information. The output information is, as discussed above, relatively simple design information obtained at a design modeling the circuit cell and the wiring, and has contents shown in FIGS. 5A through 10B, for example. Such information is hereinafter called “initial mounting design information”.

The initial mounting design information is verified (checked by designer's eyes) again in step S13 of FIG. 2. Next, based on the completed initial mounting design information, the detailed design process accompanying the timing analysis of step S14 in FIG. 2 is performed. The detailed mounting design including physical wiring on an actual substrate is performed following the initial mounting design, and the signal transmission delay situation is verified in detail based on the detailed design. After that, as discussed above, steps S14 and S15 are repeated and detailed design change correction is added so that the final detail mounting design is completed. The contents of the final detail mounting design are drawn and then sent to a manufacturing process via the final simulation test of step S6.

Next, an example of the wiring efficiency improvement and wiring change process of the embodiment of the present invention are discussed with references to FIG. 5A through FIG. 10B.

FIG. 5A and FIG. 5B are views for explanation of the example of wiring efficiency improvement processing by the wiring efficiency improvement method of the embodiment of the present invention, namely part 1 of a local wiring change. FIG. 5A shows the logic information and wiring information read in step S31 in FIG. 4 or a state where the wiring process is virtually performed in step S33. In the case shown in FIG. 5A, wiring between ports x1 and a2 and a wiring between ports x2 and a1 cross. It is possible to easily assume such a crossing state by a logic connection relationship between the cells, the initial arrangement of the cells, and an arrangement relationship of arrangement coordinates of ports on the cell, or the like. In step S34 of FIG. 4, such a part where such a wiring crossing state is expected to be generated is extracted. In steps S37 and S38, the logic is corrected (a connection port of the output side AND element is changed) at such parts (for example, see FIG. 5B). In step S39, whether the wiring efficiency is improved as a result of the correction is verified. More specifically, whether the whole wiring length is shortened is determined.

When the wiring crossing as shown in FIG. 5A happens, in the case of the detailed mounting design, it is necessary to perform detour wiring so that a part of the wiring moves to another layer via a via forming part to prevent generation of a wiring short-circuit at the crossing part. Hence, wiring crossings should be avoided from the perspective of wiring efficiency. In a state shown in FIG. 5B, the wiring crossing problem is solved and the whole wiring length is shortened. The wiring efficiency is more improved than the state shown in FIG. 5A. It is possible to determine whether there is a wiring crossing, evaluate the wiring efficiency, and calculate the whole wiring length by using an evaluation function of an automatic wiring tool following the well-known Manhattan architecture, for example.

The same thing can be applied to examples shown in FIG. 6A and FIG. 6B. The wiring cross is better solved in the state shown in FIG. 6B, the whole wiring length is more shortened in the state shown in FIG. 6B, and the wiring efficiency is more improved in the state shown in FIG. 6B, than the state shown in FIG. 6A. In the case where wiring efficiency is improved (“YES” in step S39), the wiring is applied (step S40).

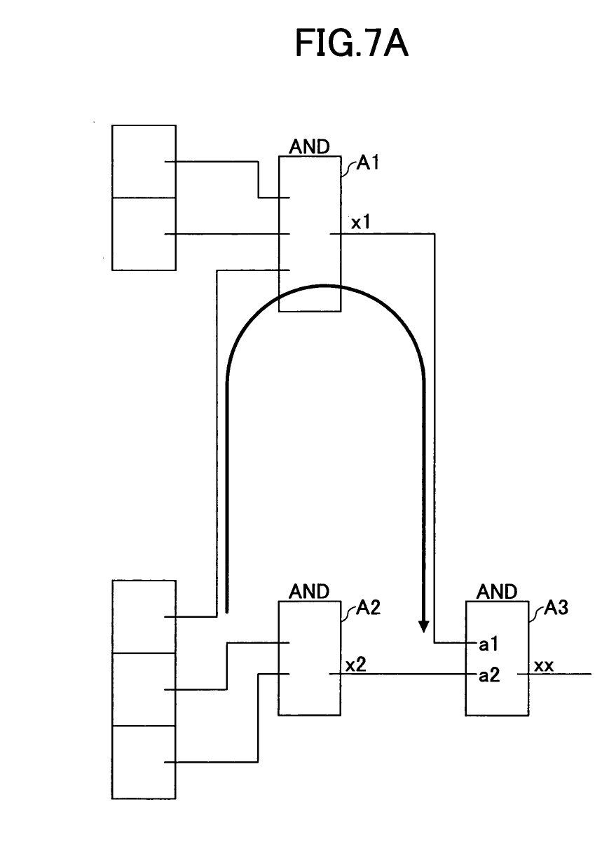

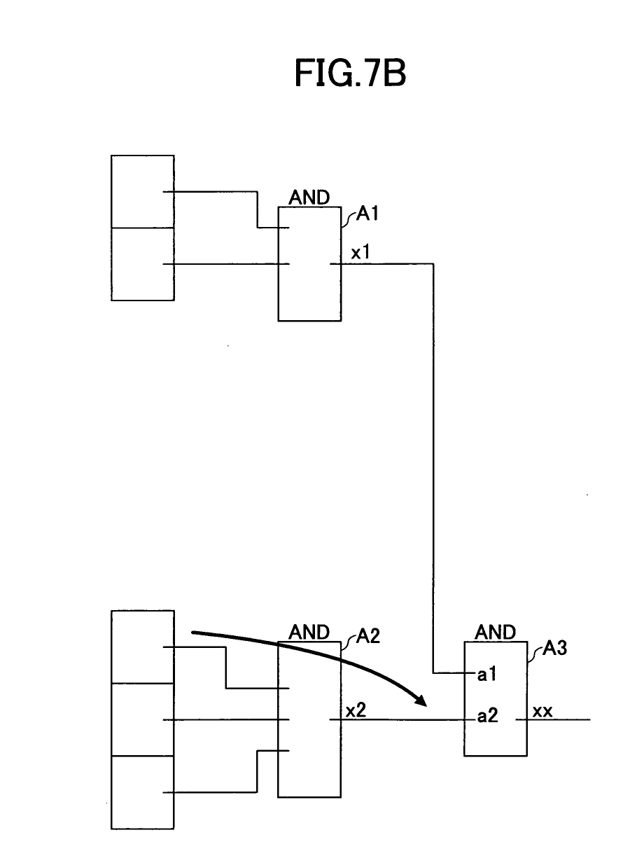

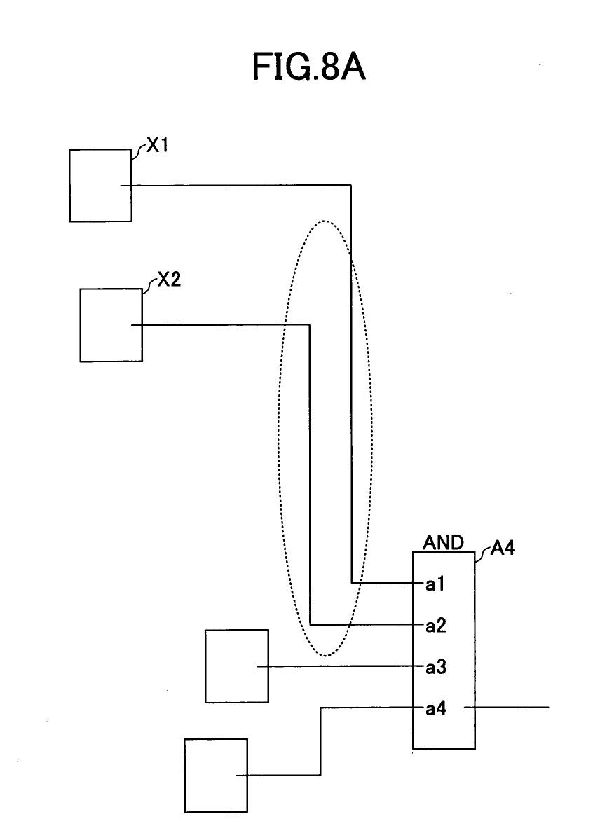

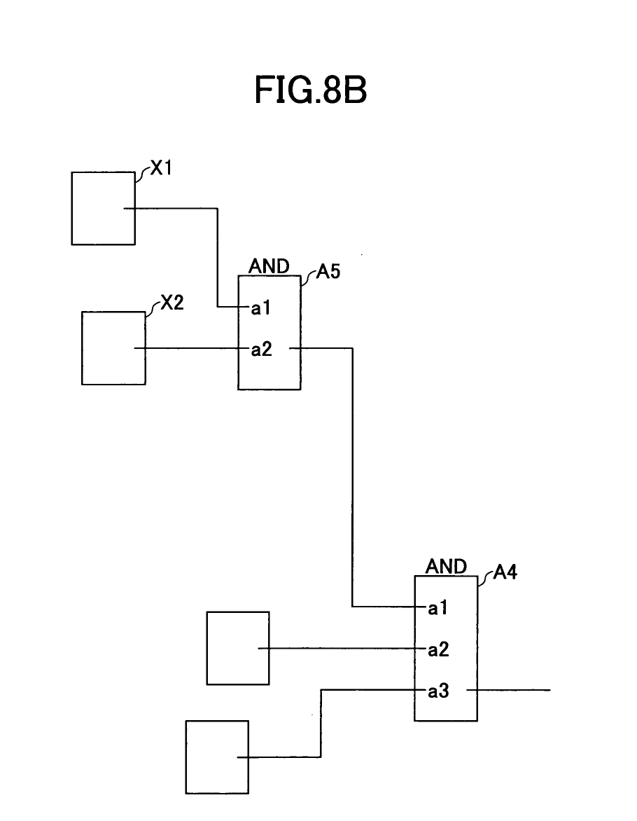

Next, broad view improvement examples of wiring efficiency improvement of the embodiment of the present invention are discussed with reference to FIG. 7A, FIG. 7B, FIG. 8A and FIG. 8B. In this case, in step S34 in FIG. 4, a logic change pattern where an equivalent logic is guaranteed even if a circuit logic per se is rearranged is extracted. From a connection relationship or arrangement relationship of the extracted logic change pattern, a logic change pattern whereby the whole wiring length is shortened as a result is extracted. In this case, the logic change pattern means a logic conversion pattern whereby the whole wiring length is shortened without substantially changing logical expressions such as a change from a state shown in FIG. 7A to a state shown in FIG. 7B, or change from a state shown in FIG. 8A to a state shown in FIG. 8B.

That is, in the example shown in FIG. 7A the signal transmission path shown by a broad arrow goes through a far AND element A1 and thereby a large amount of signal transmission delay happens. By performing logic conversion so that the signal transmission path shown goes through a near AND element A2 as shown in FIG. 7B, it is possible to shorten the wiring length forming corresponding signal transmission paths while the equivalent logic is maintained as a whole circuit going to an AND element A3. In the conventional art, the driving force is increased, by such as a repeater being inserted, so as to reduce the signal transmission delay in this case. However, by performing the wiring change accompanied by the logic conversion as shown in FIG. 7B, it is possible to effectively shorten the signal transmission delay, including shortening the whole wiring length, without adding elements such as the repeater.

In examples shown in FIG. 8A and FIG. 8B, two wirings having relatively long lengths are arranged in parallel at a portion surrounded by a dotted line in a state shown in FIG. 8A. Such a state may cause generation of noise in an actual circuit and therefore should be preferably avoided. In this case, as shown in FIG. 8B, two wirings are put together at a position near cells X1 and X2 by adding an AND element A5 so that a wiring to a cell A4 is made single. By performing a wiring change including such a logic conversion, while the logic to the cell A4 is maintained equivalent, it is possible to effectively shorten the whole wiring length, providing a solution for a state where two long wirings are closely arranged in parallel.

After such a logic conversion pattern is extracted, a virtual logic conversion and virtual wiring are performed in steps S37 and S38. In a case where the wiring amount is reduced (“YES” in step S39), logic conversion information is formed (step S40). “AND” mentioned in the drawings represents an AND logic element (AND circuit).

It is preferable that a wiring efficiency improvement process including such a logic conversion be timely performed via information conversion between the logic design in step S3 and the mounting design in step S4. By timely information conversion between the logic design and the mounting design, it is possible to effectively perform the whole circuit mounting design process including the wiring efficiency improvement process so that it is possible to effectively shorten the whole design time and the number of design processes.

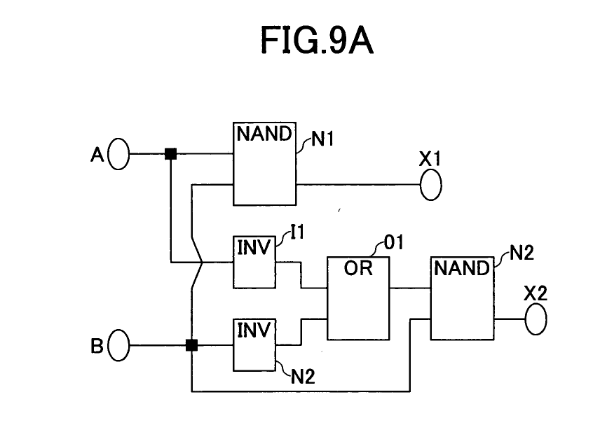

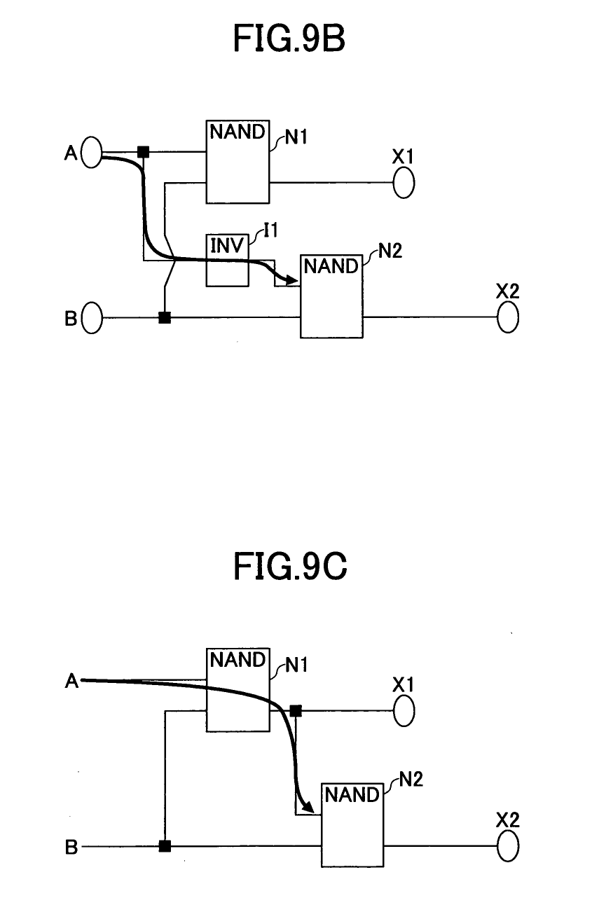

FIG. 9A through FIG. 9C show an example of wiring efficiency improvement including another broad view logic conversion. In this case, a logical expression equivalent to the original circuit logic shown in FIG. 9A is examined and an arrangement relationship between input side cells A and B and output side cells X1 and X2 is considered, so that a logic change to achieve effective wiring efficiency improvement is performed. More specifically, by performing the logic conversion from the state shown in FIG. 9A to the state shown in FIG. 9C via the state shown in FIG. 9B, it is possible to reduce the whole wiring length and effectively reduce the number of the cells while the equivalent logic is maintained as a whole.

For example, an input to a NAND element N2 at a signal path shown by a broad line in FIG. 9B is changed from via an inverter I1 to via a NAND element N1 in FIG. 9C. Even if such a change is performed, as shown in the following logic expressions, the entire circuit logic is maintained equivalent. The following logical expression 1 shows the circuit logic of FIG. 9B. The logical expression 2 shows a state where the circuit logic of FIG. 9B is led from the circuit logic of FIG. 9C.

Logical Expression 1)
X1\overline{A·B}
X2=\overline{A·B}
Logical Expression 2)
X1=\overline{A·B}

$$\begin{matrix}X2 = \overline{X1 \cdot B} \\ = \overline{\overline{A \cdot B} \cdot B} \\ = \overline{( \overline{A} + \overline{B} ) \cdot B} \\ = \overline{\overline{A} \cdot B}\end{matrix}$$

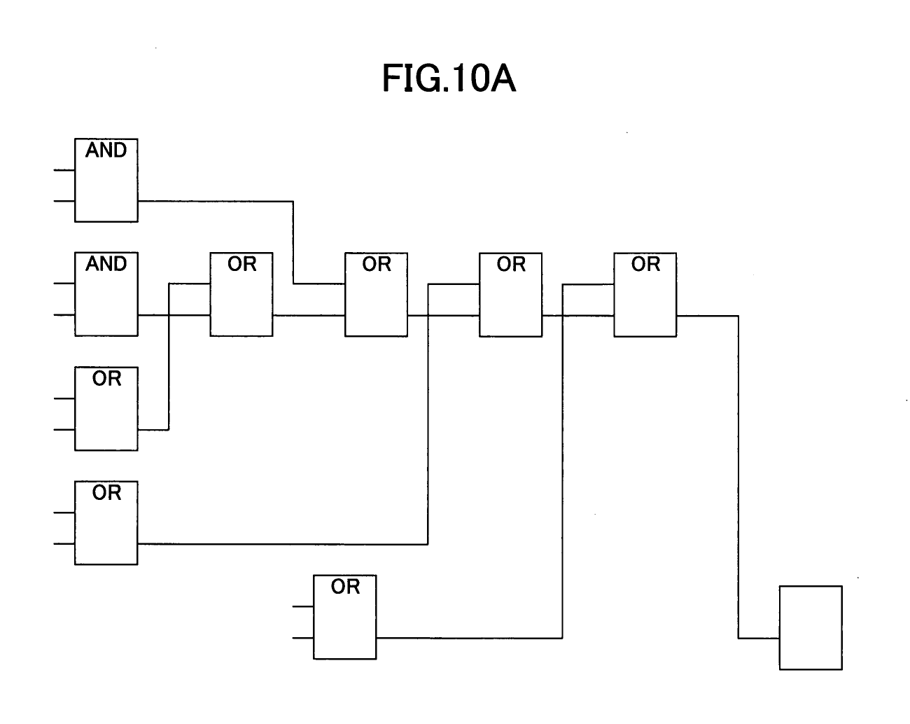

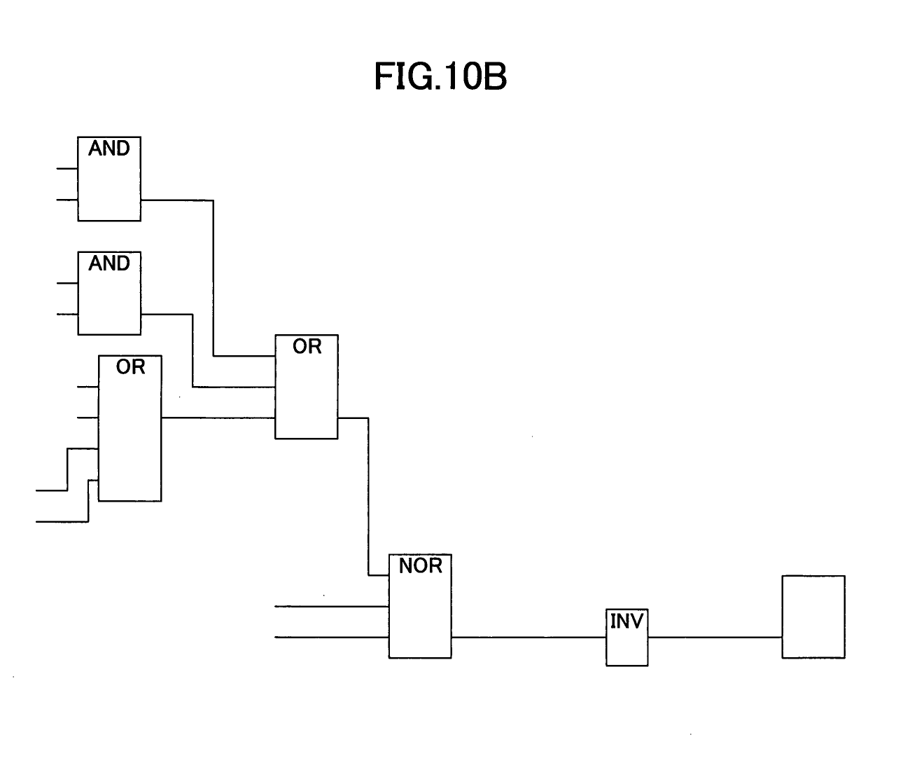

FIG. 10A and FIG. 10B show an example of wiring efficiency improvement including another broad view logic conversion. A circuit shown in FIG. 10B is obtained by examining a logical expression equivalent to an original circuit logic shown in FIG. 10A, performing a virtual logic change and virtual wiring as following the result of the examination so that the signal transmission delay result can be assumed, and obtaining a proper logic structural state among conversion candidates.

Thus, in the embodiment of the present invention, the virtual wiring process is performed based on the arrangement position of the cells and the connection relationship after the initial arrangement of the cells are completed before the mounting wiring design is performed. For the final purpose of the connection relationship of the cells expected to have the wiring efficiency improvement (prevention of the generation of the detour, easing the wiring congestion), automatic rearrangement of the wiring including the conversion of the logic is performed. At that time, a macro conversion or connection conversion is performed in a state where the equivalent circuit logic is guaranteed so that the improvement of the wiring efficiency as the whole of the circuit is automatically realized.

The following process is preferable. That is, the logic, arrangement, and wiring information (initial mounting design information) having contents shown in FIG. 5A through FIG. 10A and obtained by the automatic wiring deign tool are read by the computer. Extraction of improvement candidates by the wiring efficiency improvement application of the embodiment, the virtual logic conversion and wiring process following the extracted candidates, the evaluation of the wiring efficiency improvement effect against the result, application of the proper improvement idea based on the evaluation result, an indication of the improved contents following the applied idea to the operator, the output of the result, and others are implemented by an automatic process by the computer.

It is preferable that an automatic wiring process on the design and the signal transmission delay calculation be performed after the logic conversion, results before and after the conversion be graphically indicated, and a list indication be performed, for example. Under this structure, it is possible for a designer, namely the user, to easily realize how the wiring efficiency improvement is performed and how many effects are obtained.

Under this structure, it is possible to reduce the generation of the detour of the wiring in advance before the actual and final detailed mounting design. Furthermore, since inefficient wiring can be reduced in advance as much as possible, it is possible to effectively reduce the wiring process time at the time of the final detailed mounting design so that the number of the processes of the mounting design can be reduced and thereby it is possible to reduce the cost of the design. As a result of this, the LSI layout can be improved and the chip size may be made small and thereby it is possible to make further cost reductions of manufacturing. In addition, by reducing the detour wiring, the ratio of the generation of short-circuit or open malfunctions can be decreased and the yield rate is expected to be improved.

That is, according to the embodiment of the present invention, the connection relationship at a logical local point is rearranged by considering wiring efficiency, or the broad view logic conversion is performed while the equivalent logic is maintained so that the wiring efficiency is improved. Furthermore, it is possible to efficiently perform the mounting design by performing the feedback of the circuit logic obtained by the logic conversion, arrangement, or change, to the mounting design information. Furthermore, it is possible to form a user friendly system by performing wiring based on the logic conversion and indicating a result of a signal transmission delay calculation in this case. The above-discussed local wiring change is subject to a connection between the cells of a single step. The above-discussed broad view wiring change is subject to a connection between the cells of plural steps.

According to the above-discussed embodiment of the present invention, it is possible to achieve various effects such as decrease of detour wiring based on the reduction of wiring crossings, reduction of the wiring amount by performing the logic conversion (namely macro conversion), shortening the signal transmission delay (improvement of through-rate and fan-out), prevention of increase of the gate size (repeater is not necessary), reduction of the manufacturing cost, decrease of the number of the design processes, improvement of the yield rate (reduction of the generation of short-circuit and open errors).

The present invention is not limited to these embodiments, but variations and modifications may be made without departing from the scope of the present invention.

1. A circuit arrangement design method, comprising:
a step of performing a logic conversion of logic, the logic forming a circuit arrangement where a cell arrangement and a connection arrangement between cells are provisionally arranged prior to a detailed mounting design, and thereby wiring efficiency is improved.

2. The circuit arrangement design method as claimed in claim 1, further comprising:
a step of changing a wiring design so that a wiring crossing is eliminated in performing an arrangement design.

3. The circuit arrangement design method as claimed in claim 1,
wherein the logic conversion is performed in a state where new logic obtained by the logic conversion becomes equivalent to the logic prior to the conversion.

4. The circuit arrangement design method as claimed in claim 1,
wherein the wiring efficiency is achieved by performing at least one of cutback of a whole wiring length, removal of a wiring crossing, and removal of a local wiring concentration.

5. A circuit arrangement design program implemented by a computer, comprising an instruction for implementing a step of:
performing a logic conversion of logic, the logic forming a circuit arrangement where a cell arrangement and a connection arrangement between cells are provisionally arranged prior to a detailed mounting design, and thereby wiring efficiency is improved.

6. The circuit arrangement design program as claimed in claim 5, further comprising an instruction for implementing a step of:
changing a wiring design so that a wiring crossing is eliminated in performing an arrangement design.

7. The circuit arrangement design program as claimed in claim 5,
wherein the logic conversion is performed in a state where new logic obtained by the logic conversion becomes equivalent to the logic prior to the conversion.

8. The circuit arrangement design program as claimed in claim 5,
wherein the wiring efficiency is achieved by performing at least one of cutback of a whole wiring length, removal of a wiring crossing, and removal of a local wiring concentration.
